(19) United States
(12) Patent Application Publication
(10) Pub. No.: US 2012/0040723 A1
(43) Pub. Date: Feb. 16, 2012

(54) ELECTRONIC DEVICE AND OUTER PANEL FOR ELECTRONIC DEVICE

(75) Inventors: Toru Kurihara, Kawasaki (JP); Masayuki Sato, Kawasaki (JP); Kazuhiro Kakuguchi, Kawasaki (JP)

(73) Assignee: FUJITSU LIMITED, Kawasaki-shi (JP)

(21) Appl. No.: 13/204,141

(22) Filed: Aug. 5, 2011

(30) Foreign Application Priority Data
Aug. 16, 2010 (JP) 2010-181583

(51) Int. Cl. H04W 88/02

(52) U.S. Cl. 455/566; 455/575.8

(57) ABSTRACT

An electronic device includes a display unit, a protective member disposed on the display unit to protect the display unit, a surface member disposed on the same plane as the protective member and a waterproof sheet covering at least a gap between the protective member and the surface member, the waterproof sheet is disposed between the display unit and the protective and surface members.

### CROSS-REFERENCE TO RELATED APPLICATIONS

This application is based upon and claims the benefit of priority of the prior Japanese Patent Application No. 2010-181583, filed on Aug. 16, 2010, the entire contents of which are incorporated herein by reference.

### FIELD

The embodiment discussed herein is related to a technical field of an electronic device, such as a mobile phone, and an outer panel of the electronic device.

### BACKGROUND

Electronic devices like mobile phones have a display unit, such as a liquid crystal display or an organic electro-luminescence (EL) display. Japanese laid-open patent publication No. 2008-83263 and Japanese laid-open patent publication No. 2009-8703 disclose methods for ensuring the water-tightness of a mobile phone by covering the body of a mobile phone including the display unit with a single outer panel.

### SUMMARY

According to an aspect of an embodiment, an electronic device includes a display unit, a protective member disposed on the display unit to protect the display unit, a surface member disposed on the same plane as the protective member and a waterproof sheet covering at least a gap between the protective member and the surface member, the waterproof sheet is disposed between the display unit and the protective and surface members.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating the exterior of a front-side part of a mobile phone according to this embodiment in an open state.

FIG. 2 is a perspective view illustrating the exterior of a rear-side part of the mobile phone according to this embodiment in an open state.

FIG. 3A is a side view, and FIGS. 3B and 3C are perspective views illustrating the exterior of the mobile phone according to this embodiment in a closed state.

FIGS. 4A and 4B are perspective views illustrating a detailed configuration of a display unit.

FIG. 5A is an exploded perspective view and FIG. 5B is an exploded cross-sectional view, respectively, illustrating a detailed configuration of a front-side part of the display unit, in which respective components of the front-side part are illustrated in an exploded manner.

FIG. 6A is an exploded perspective view and FIG. 6B is an exploded cross-sectional view, respectively, illustrating a detailed configuration of a rear-side part of the display unit, in which respective components of the rear-side part are illustrated in an exploded manner.

FIG. 7A is an exploded perspective view and FIG. 7B is an exploded cross-sectional view, respectively, illustrating a detailed configuration of a front-side part according to a first modification, in which respective components of the front-side part are illustrated in an exploded manner.

FIG. 8A is an exploded perspective view and FIG. 8B is an exploded cross-sectional view, respectively, illustrating a detailed configuration of a rear-side part according to the first modification, in which respective components of the rear-side part are illustrated in an exploded manner.

FIG. 9A is an exploded perspective view and FIG. 9B is an exploded cross-sectional view, respectively, illustrating a detailed configuration of a front-side part according to a second modification, in which respective components of the front-side part are illustrated in an exploded manner.

FIG. 10A is an exploded perspective view and FIG. 10B is an exploded cross-sectional view, respectively, illustrating a detailed configuration of a rear-side part according to the second modification, in which respective components of the rear-side part are illustrated in an exploded manner.

### DESCRIPTION OF EMBODIMENTS

In the body of a mobile phone including a display unit, when an outer panel including a panel portion for covering the display unit and a panel portion for covering a portion other than the display unit is used to improve the flexibility of decorating the mobile phone, the two panel portions may have different thicknesses due to difference in specification between the two panel portions. In addition, the shape of a casing frame that receives the outer panel including these panel portions becomes complex. Thus, sink marks may occur while forming the outer panel or the casing frame. Such sink marks make it difficult to maintain water-tightness between the outer panel and the casing frame.

An exemplary method for overcoming this problem is that the outer panel is divided, as separate components, into a panel portion for covering the display unit and a panel portion for covering a portion other than the display unit. However, because one outer panel is divided into a plurality of panel portions, it is difficult to maintain water-tightness at the boundary of the divided panel portions.

This situation occurs not only in mobile phones, but also in any electronic device having a display unit.

Embodiments of the present invention will be described below with reference to the drawings. In the following description, a mobile phone, which is an example of the electronic device, will be described. However, the configuration described below may be applied not only to mobile phones, but also to other various electronic devices (for example, PDAs, mini-personal computers, notebook personal computers, and desktop personal computers).

### 1. Exterior of Mobile Phone

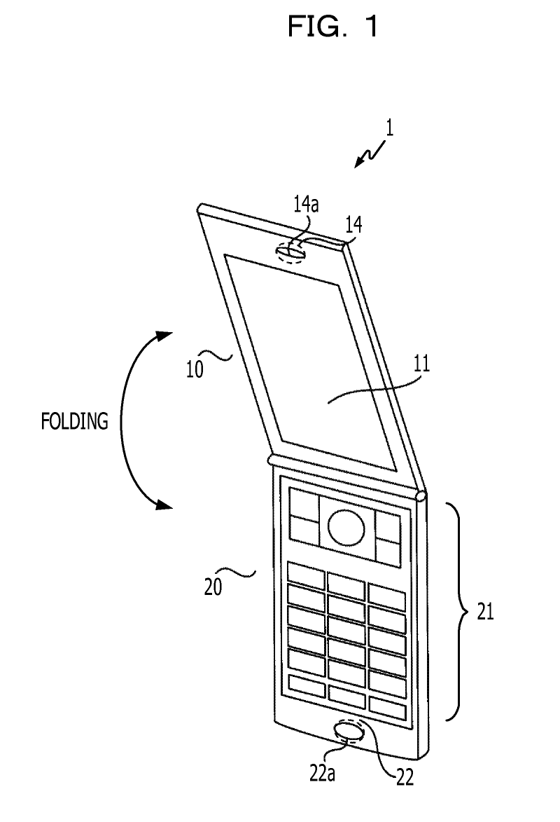

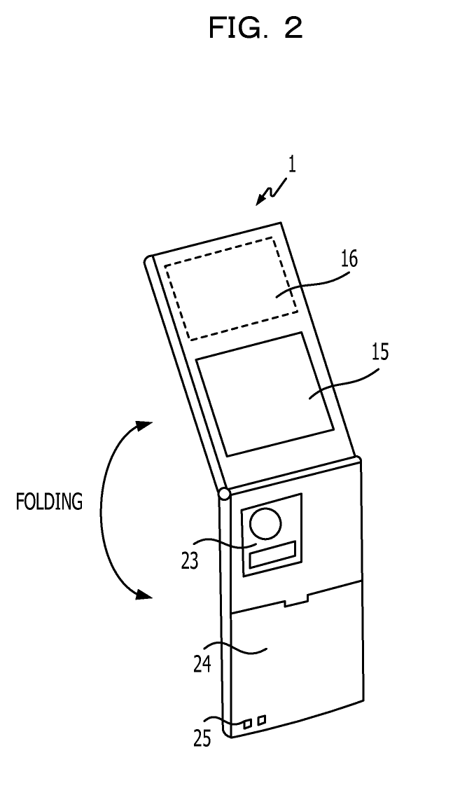

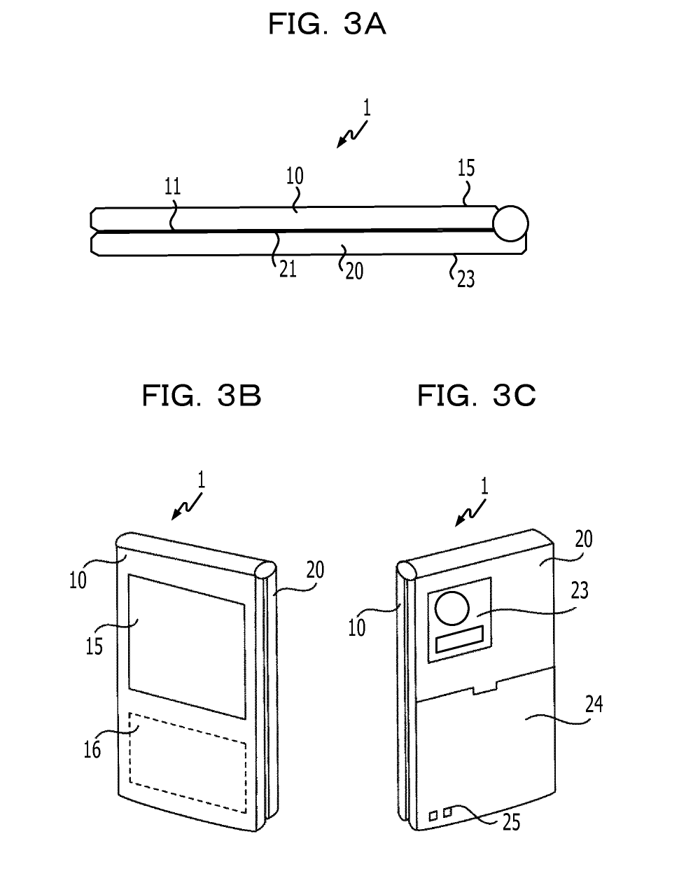

Referring to FIGS. 1 to 3C, the exterior of a mobile phone 1 according to this embodiment will be described. FIG. 1 is a perspective view illustrating the exterior of a front-side part of a mobile phone 1 according to this embodiment in an open state. FIG. 2 is a perspective view illustrating the exterior of a rear-side part of the mobile phone 1 according to this embodiment in an open state. FIG. 3A is a side view, and FIGS. 3B and 3C are perspective views illustrating the exterior of the mobile phone 1 according to this embodiment in a closed state.

Although the mobile phone 1 of a foldable type will be described below, the configuration described below may be applied to mobile phones having other shapes (for example, straight mobile phones or slidable mobile phones). FIGS. 1 to 3C selectively illustrate the configurations necessary for the description of the mobile phone 1 according to this embodiment. Thus, the mobile phone 1 according to this embodiment may include other configurations (not illustrated) that are necessary for a mobile phone.

As illustrated in FIGS. 1 and 2, the mobile phone 1 includes a display unit 10 and an operation unit 20. Note that FIGS. 1 and 2 illustrate the mobile phone 1 in an unfolded state (i.e., in an open state).

As illustrated in FIG. 1, the display unit 10 includes a main display 11 and an ear piece 14 on the front side (inner side) thereof. The main display 11 is an example of the “display unit” and indicates information (for example, characters, images, and patterns). For example, the main display 11 indicates the current time, the charging status of the mobile phone 1, the signal strength of the mobile phone 1, the record of incoming and outgoing calls, the address book, and e-mail messages. For example, the main display 11 is a liquid crystal display or an organic EL display. The ear piece 14 has a speaker 14a therein. A user of the mobile phone 1 may hear audio output from the speaker 14a.

Similarly, as illustrated in FIG. 1, the operation unit 20 has a plurality of operation buttons 21 and a mouth piece 22 on the front side thereof. A user operates the operation buttons 21 including, for example, number buttons, a power button, a talk button, a mail button, and a cross-bar button. The mouth piece 22 has a microphone 22a therein. A user of the mobile phone 1 inputs audio into the mobile phone 1 through the microphone 22a.

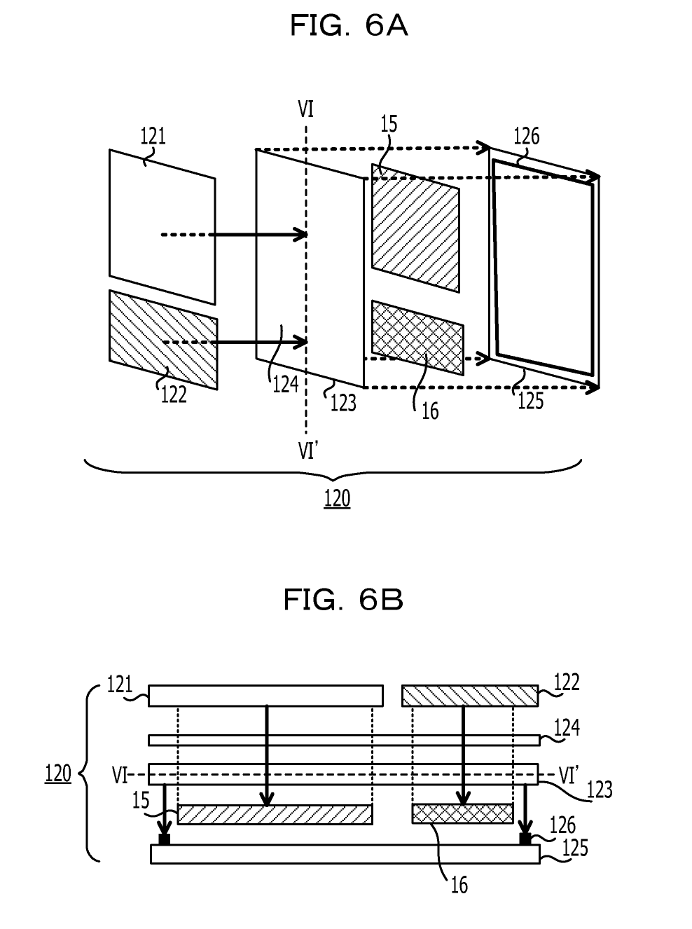

On the other side, as illustrated in FIG. 2, the display unit 10 includes a sub-display 15 and an electrostatic sensor 16 on the rear side (outer side) thereof. The sub-display 15 is an example of the “display unit” and indicates information (for example, characters, images, and patterns). For example, the sub-display 15 indicates the current time, the charging status of the mobile phone 1, and the signal strength of the mobile phone 1. For example, the sub-display 15 is a liquid crystal display or an organic EL display. The electrostatic sensor 16 detects an operation by a user sweeping across the rear surface of the display unit 10 where the electrostatic sensor 16 is disposed and outputs a signal according to the operation. The electrostatic sensor 16 may be covered by a plastic panel 122 (see FIGS. 6A and 6B, described below), and thus, it does not have to be exposed outside the display unit 10.

Similarly, as illustrated in FIG. 2, the operation unit 20 includes a camera 23 for capturing, for example, images and movies, a rechargeable battery (not illustrated), a battery lid 24 covering the rechargeable battery, metal charging terminals 25 for charging the rechargeable battery, etc., on the rear side thereof.

As illustrated in FIGS. 1 and 2, the mobile phone 1 according to this embodiment is a foldable mobile phone that may be folded in such a manner that the display unit 10 is brought toward the operation unit 20 in the direction indicated by the dual arrow. As a result, as illustrated in FIG. 3A, the mobile phone 1 is folded in such a manner that the main display 11 of the display unit 10 faces the operation buttons 21 of the operation unit 20 (i.e., a closed state).

As illustrated in FIG. 3B, the rear surface of the display unit 10 (i.e., the sub-display 15 and the electrostatic sensor 16) of the closed mobile phone 1 may be disposed outside, and the front surface of the display unit 10 (i.e., the main display 11 and the ear piece 14) of the closed mobile phone 1 does not have to be exposed outside. Note that, however, the rear surface of the display unit 10 of the closed mobile phone 1 does not have to be exposed outside, and the front surface thereof may be exposed outside.

Similarly, as illustrated in FIG. 3C, the rear surface of the operation unit 20 (i.e., the camera 23, the battery lid 24, and the charging terminals 25) of the closed mobile phone 1 may be exposed outside, and the front surface of the operation unit 20 (i.e., the operation buttons 21 and the mouth piece 22) of the closed mobile phone 1 does not have to be exposed outside. Note that, however, the rear surface of the operation unit 20 of the closed mobile phone 1 does not have to be exposed outside, and the front surface thereof may be exposed outside.

### 2. Configuration of Display Unit

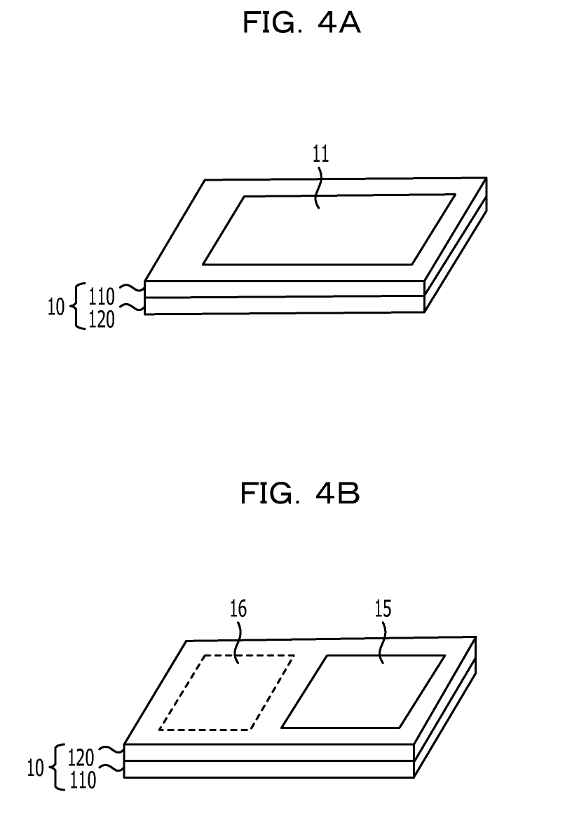

Referring to FIGS. 4A and 4B, a detailed configuration of the display unit 10 will be described. FIGS. 4A and 4B are perspective views illustrating a detailed configuration of the display unit 10.

As illustrated in FIGS. 4A and 4B, the display unit 10 includes a front-side part 110 having front-side components (i.e., the main display 11 and the ear piece 14), and a rear-side part 120 having rear-side components (i.e., the sub-display 15 and the electrostatic sensor 16). FIG. 4A illustrates the display unit 10 as viewed from the front-side part 110, and FIG. 4B illustrates the display unit 10 as viewed from the rear-side part 120.

The front-side part 110 and the rear-side part 120 are fixed or bonded to each other with, for example, a predetermined bonding member (e.g., an adhesive or a screw). At this point, as illustrated in FIGS. 4A and 4B, the front-side part 110 and the rear-side part 120 are fixed or bonded to each other such that the surfaces thereof opposite to the surfaces having the main display 11 or the sub-display 15 face each other. In other words, as illustrated in FIGS. 4A and 4B, the front-side part 110 and the rear-side part 120 are fixed or bonded to each other such that the main display 11 and the sub-display 15 may be viewed from the outside.

### 3. Configuration of Front-Side Part of Display Unit

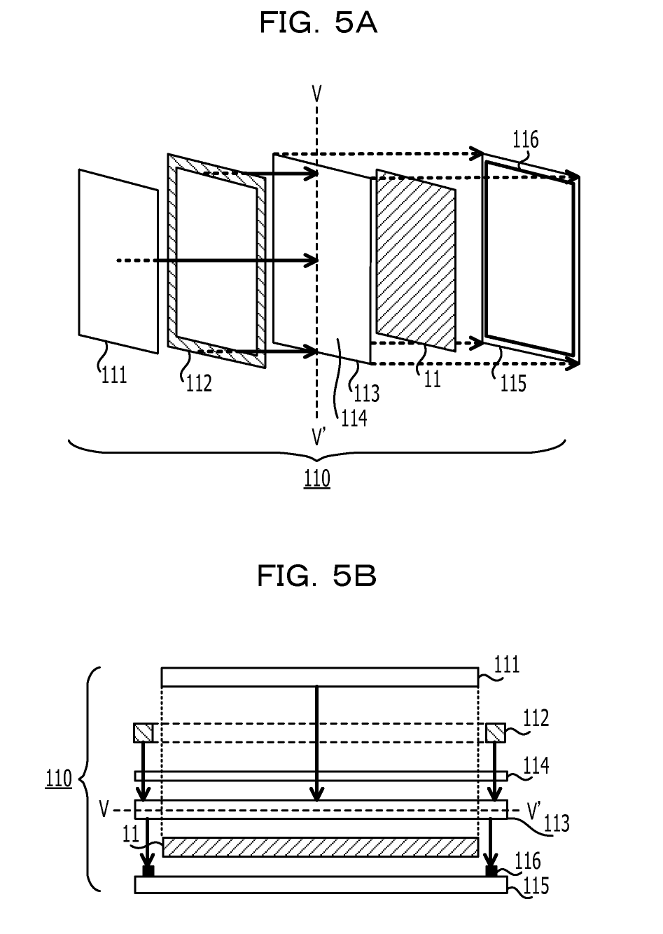

Referring to FIGS. 5A and 5B, a detailed configuration of the front-side part 110 of the display unit 10 will be described. FIG. 5A is an exploded perspective view and FIG. 5B is an exploded cross-sectional view, respectively, illustrating a detailed configuration of the front-side part 110 of the display unit, in which respective components of the front-side part 110 are illustrated in an exploded manner.

As illustrated in FIGS. 5A and 5B, the front-side part 110 includes a plastic panel 111, a plastic panel 112, a polyethylene terephthalate (PET) sheet 113, the main display 11, and a front frame (front casing) 115. FIG. 5B illustrates a cross-sectional view taken along line V-V′ in FIG. 5A.

The plastic panel 111 is an example of the protective member and is a plastic panel (or a thin plate) for protecting the main display 11. The plastic panel 111 is disposed in the front-side part 110 so as to overlap the main display 11 in a direction normal to the plastic panel 111. For example, the plastic panel 111 may be disposed such that a part or the entirety of the plastic panel 111 overlaps a part or the entirety of the main display 11. The plastic panel 111 transmits light.

The plastic panel 112 is an example of the surface member and is disposed on the same plane as the plastic panel 111. Preferably, the plastic panel 112 is disposed at a position not overlapping the main display 11 (or the plastic panel 111) in a direction normal to the plastic panel 112. In the example illustrated in FIGS. 5A and 5B, a configuration is employed in which the plastic panel 112 has a frame-like shape with an opening having a size equal to or larger than the main display 11 (or a size equal to or larger than the plastic panel 111) and in which the plastic panel 111 is fitted into the opening. Note that, in FIGS. 5A and 5B, the plastic panel 112 is indicated with hatching, and a portion surrounded by the hatched plastic panel 112 is the opening. The plastic panel 112 may be disposed at a position overlapping a part of the main display 11 (or a part of the plastic panel 111) in a direction normal to the plastic panel 112. Predetermined decoration may be applied to the surface or inside of the plastic panel 112. Examples of such decoration include printing or engraving characters, numbers, or pictures, coloring with predetermined colors, and polishing. In addition, when a light emitting device, such as a light emitting diode (LED) is disposed between the plastic panel 112 and the front frame 115, the plastic panel 112 may have a hole provided as predetermined decoration, through which light emitted from the light emitting device is transmitted outside. The plastic panel 112 may have either a light-transmitting property or a non-light-transmitting property.

Note that, not only plastic panels, but also panels made of other materials, such as metal, which meet the above-described conditions may be used as the plastic panels 111 and 112. Furthermore, in addition to the plastic panels 111 and 112, the front-side part 110 may include more plastic panels, according to the size, shape, and number of the main display 11, the size, shape, and number of other functional portions, and the type, shape, and number of decoration to be applied.

The PET sheet 113 is an example of the waterproof sheet and is a film-like sheet containing PET. The PET sheet 113 transmits light. Note that a film-like sheet or a thin-plate-like panel containing a material other than PET (for example, an arbitrary resin, fiber, or metal) may be used as the PET sheet 113. Predetermined decoration may be applied to the surface or inside of the PET sheet 113.

The plastic panels 111 and 112 are bonded to one surface of the PET sheet 113 with an optically clear adhesive (OCA) 114. However, the plastic panels 111 and 112 may be bonded to one surface of the PET sheet 113 with an optical adhesive (or a light-transmitting adhesive) other than the OCA 114. The arrows in FIGS. 5A and 5B indicate attaching conditions of the plastic panels 111 and 112 to the PET sheet 113. Accordingly, the PET sheet 113 is larger in size than the plastic panels 111 and 112 in a surface direction. However, as will be described in first and second modifications below, the PET sheet 113 may be smaller in size than the plastic panels 111 and 112 in a surface direction. Although FIGS. 5A and 5B illustrate an example in which the OCA 114 is applied over the entire surface of the PET sheet 113, the OCA 114 may be applied between the PET sheet 113 and the plastic panel 111, and between the PET sheet 113 and the plastic panel 112. In other words, the OCA 114 does not have to be applied to a portion of the PET sheet 113 corresponding to the gap between the plastic panels 111 and 112.

The other surface of the PET sheet 113 (i.e., the surface opposite to the surface to which the plastic panels 111 and 112 are attached) is attached to the front frame 115 with a double-faced adhesive tape (hereinafter referred to as a “double-faced tape”) 116. However, the other surface of the PET sheet 113 may be attached to the front frame 115 with an arbitrary bonding member (e.g., an adhesive or a screw) other than the double-faced tape 116. The PET sheet 113 has a size sufficient to sandwich the entire main display 11 with respect to the front frame 115. In addition, the double-faced tape 116 for attaching the PET sheet 113 to the front frame 115 is preferably disposed on the front frame 115 (or the PET sheet 113) such that the entire main display 11 is positioned on the inner side of the double-faced tape 116. Furthermore, the double-faced tape 116 is disposed so as to form a closed loop on the front frame 115 (or the PET sheet 113) so that the water-tightness of the main display 11 positioned on the inner side of the double-faced tape 116 may be ensured.

The PET sheet 113 to which the plastic panels 111 and 112 are attached is an example of the outer panel.

The front frame 115 is a frame (or a casing) that constitutes the exterior of the front-side part 110. A surface of the front frame 115 opposite to the surface to which the main display 11 is mounted is attached to a rear frame 125. Thus, the display unit 10 is formed.

### 4. Configuration of Rear-Side Part of Display Unit

Referring to FIGS. 6A and 6B, a detailed configuration of the rear-side part 120 of the display unit 10 will be described. FIG. 6A is an exploded perspective view and FIG. 6B is an exploded cross-sectional view, respectively, illustrating a detailed configuration of the rear-side part 120 of the display unit 10, in which respective components of the rear-side part 120 are illustrated in an exploded manner.

As illustrated in FIGS. 6A and 6B, the rear-side part 120 includes a plastic panel 121, a plastic panel 122, a PET sheet 123, the sub-display 15, the electrostatic sensor 16, and a rear frame (rear casing) 125. FIG. 6B illustrates a cross-sectional view taken along line VI-VI′ in FIG. 6A.

The plastic panel 121 is an example of the protective member and is a plastic panel (or a thin plate) for protecting the sub-display 15. The plastic panel 121 is preferably disposed in the rear-side part 120 so as to overlap the sub-display 15 in a direction normal to the plastic panel 121. For example, the plastic panel 121 may be disposed such that a part or the entirety of the plastic panel 121 overlaps a part or the entirety of the sub-display 15. The plastic panel 121 transmits light.

The plastic panel 122 is an example of the surface member and is disposed on the same plane as the plastic panel 121. The plastic panel 122 is disposed at a position not overlapping the sub-display 15 (or the plastic panel 121) in a direction normal to the plastic panel 122. In the example illustrated in FIGS. 6A and 6B, the plastic panel 122 is disposed adjacent to the plastic panel 121. However, the plastic panel 122 may be disposed at a position overlapping a part of the sub-display 15 (or a part of the plastic panel 121) in a direction normal to the plastic panel 122. The surface of the plastic panel 122 may be processed (for example, flattened to form an outer surface of a touch pad) to enable an operation using the electrostatic sensor 16. Alternatively, other predetermined decoration may be applied to the surface or inside of the plastic panel 122. Furthermore, when a light emitting device, such as an LED, is disposed between the plastic panel 122 and the rear frame 125, the plastic panel 122 may have a hole provided as predetermined decoration, through which light emitted from the light emitting device is transmitted outside. The plastic panel 122 may have either a light-transmitting property or a non-light-transmitting property.

Note that, not only plastic panels, but also panels made of other materials, such as metal, which meet the above-described conditions may be used in place of the plastic panels 121 and 122. Furthermore, in addition to the plastic panel 121 and the 122, the rear-side part 120 may include more plastic panels according to the size, shape, and number of the sub-display 15, the size, shape, and number of the electrostatic sensor 16, the size, shape, and number of other functional portions, and the type, shape, and number of decoration to be applied.

The PET sheet 123 is an example of the waterproof sheet and is a film-like sheet containing PET. The PET sheet 123 transmits light. Note that a film-like sheet or a thin-plate-like panel containing a material other than PET (for example, an arbitrary resin, fiber, or metal) may be used as the PET sheet 123. Predetermined decoration may be applied to the surface or inside of the PET sheet 123.

The plastic panels 121 and 122 are bonded to one surface of the PET sheet 123 with an OCA 124. However, the plastic panels 121 and 122 may be bonded to one surface of the PET sheet 123 with an optical adhesive (or a light-transmitting adhesive) other than the OCA 124. The arrows in FIGS. 6A and 6B indicate attaching conditions of the plastic panels 121 and 122 to the PET sheet 123. Accordingly, the PET sheet 123 is larger in size than the plastic panels 121 and 122 in a surface direction. However, as will be described in the first and second modifications below, the PET sheet 123 may be smaller in size than the plastic panels 121 and 122 in a surface direction. Although FIGS. 6A and 6B illustrate an example in which the OCA 124 is applied over the entire surface of the PET sheet 123, the OCA 124 may be applied between the PET sheet 123 and the plastic panel 121, and between the PET sheet 123 and the plastic panel 122. In other words, the OCA 124 does not have to be applied to a portion of the PET sheet 123 corresponding to the gap between the plastic panels 121 and 122.

The other surface of the PET sheet 123 (i.e., the surface opposite to the surface to which the plastic panels 121 and 122 are attached) is attached to the rear frame 125 with a double-faced tape 126. However, the other surface of the PET sheet 123 may be attached to the rear frame 125 with an arbitrary bonding member (e.g., an adhesive or a screw) other than the double-faced tape 126. The PET sheet 123 has a size sufficient to sandwich the entire sub-display 15 and electrostatic sensor 16 with respect to the rear frame 125. In addition, the double-faced tape 126 for attaching the PET sheet 123 to the rear frame 125 is preferably disposed on the rear frame 125 (or the PET sheet 123) such that the entire sub-display 15 and electrostatic sensor 16 are positioned on the inner side of the double-faced tape 126. Furthermore, the double-faced tape 126 is disposed so as to form a closed loop on the rear frame 125 (or the PET sheet 123) so that the water-tightness of the sub-display 15 and the electrostatic sensor 16 positioned on the inner side of the double-faced tape 126 may be ensured.

The PET sheet 123 to which the plastic panels 121 and 122 are attached is an example of the outer panel.

The rear frame 125 is a frame (or a casing) that constitutes the exterior of the rear-side part 120. A surface of the rear frame 125 opposite to the surface to which the sub-display 15 and electrostatic sensor 16 are mounted is attached to the surface of the front frame 115 opposite to the surface to which the main display 11 is mounted. Thus, the display unit 10 is formed.

As has been described above, in the mobile phone 1 according to this embodiment, two independent plastic panels 111 and 112 serve as outer panels on the front-side part 110. Therefore, compared with the case where one outer panel having the same function as the plastic panels 111 and 112 is used, the flexibility of decorating the mobile phone 1 may be improved. That is, the plastic panel 111 for covering the main display 11 is formed of a transparent material using a method suitable for that material, almost or completely without taking into consideration the specification or properties required for the plastic panel 112. Similarly, the plastic panel 112 is made of a material that may be easily decorated using a method suitable for that material, almost or completely without taking into consideration the specification or properties required for the plastic panel 111. The same technical advantages may also be obtained in the two independent plastic panels 121 and 122 of the rear-side part 120.

Furthermore, in the mobile phone 1 according to this embodiment, the plastic panels 111 and 112 may be separately fabricated (for example, the plastic panels 111 and 112 may be separately designed and formed). Therefore, sink marks occurring when one outer panel having the same function as the plastic panels 111 and 112 is fabricated may be appropriately suppressed. The same technical advantages may also be obtained in the two independent plastic panels 121 and 122 of the rear-side part 120.

Furthermore, in the mobile phone 1 according to this embodiment, more plastic panels may be disposed in addition to the plastic panels 111 and 112. That is, an arbitrary or desired number of plastic panels may be attached to the PET sheet 113. This enables the mobile phone 1 to be decorated individually for each user and enables the mobile phone 1 to be easily customized.

Furthermore, in the mobile phone 1 according to this embodiment, the plastic panels 111 and 112 do not need to be stacked on top of each other in the thickness direction of the plastic panels 111 and 112. In other words, the plastic panels 111 and 112 do not need to be stacked on top of each other in the thickness direction of the mobile phone 1. Thus, the thickness of the mobile phone 1 may be reduced.

In the mobile phone 1 according to this embodiment, the gap between the plastic panels 111 and 112 is covered by the PET sheet 113. Accordingly, the PET sheet 113 prevents water droplets flowing along the gap between the plastic panels 111 and 112 from entering the inside of the front-side part 110. Thus, the water-tightness of the mobile phone 1 may be ensured. The same technical advantages may also be obtained in the PET sheet 123 of the rear-side part 120.

In the mobile phone 1 according to this embodiment, the plastic panels 111 and 112 are bonded to the PET sheet 113 with the OCA 114. Thus, degradation of the optical properties (for example, attenuation or the like of light emitted from the main display 11) due to the bonding member used for bonding the plastic panels 111 and 112 to the PET sheet 113 may be suppressed. Accordingly, the user may clearly view the content of indication on the main display 11. The same technical advantages may also be obtained even in the case where the plastic panels 111 and 112 are bonded to the PET sheet 113 with an optical adhesive other than the OCA 114. The same technical advantages may also be obtained in the OCA 124 of the rear-side part 120.

Furthermore, if the plastic panel 111 transmits light, degradation of the optical properties may be further suppressed. Similarly, if the PET sheet 113 transmits light, degradation of the optical properties may be further suppressed. Accordingly, a user may more clearly view the content of indication on the main display 11. Thus, with the mobile phone 1 according to this embodiment, the display unit 10 that transmits light from the entire surface thereof while ensuring the water-tightness may be achieved. The same technical advantages may also be obtained in the rear-side part 120.

With the mobile phone 1 according to this embodiment, the PET sheet 113 may be decorated. Therefore, variety of decoration for the mobile phone 1 may be further increased.

As has been described, the plastic panel 111 and the PET sheet 113 both transmit light. Thus, the plastic panel 111 and the PET sheet 113 may be integrally formed. Then, by bonding the plastic panel 112 to the integrally formed plastic panel 111 and PET sheet 113 with the OCA 114, a front-side part like the above-described front-side part 110 is fabricated. Similarly, the plastic panel 121 and the PET sheet 123 may be integrally formed. Then, by bonding the plastic panel 122 to the integrally formed plastic panel 121 and PET sheet 123 with the OCA 124, a rear-side part like the above-described rear-side part 120 is fabricated. Accordingly, the technical advantages as described above may also be appropriately enjoyed with this configuration.

### 5. First Modification

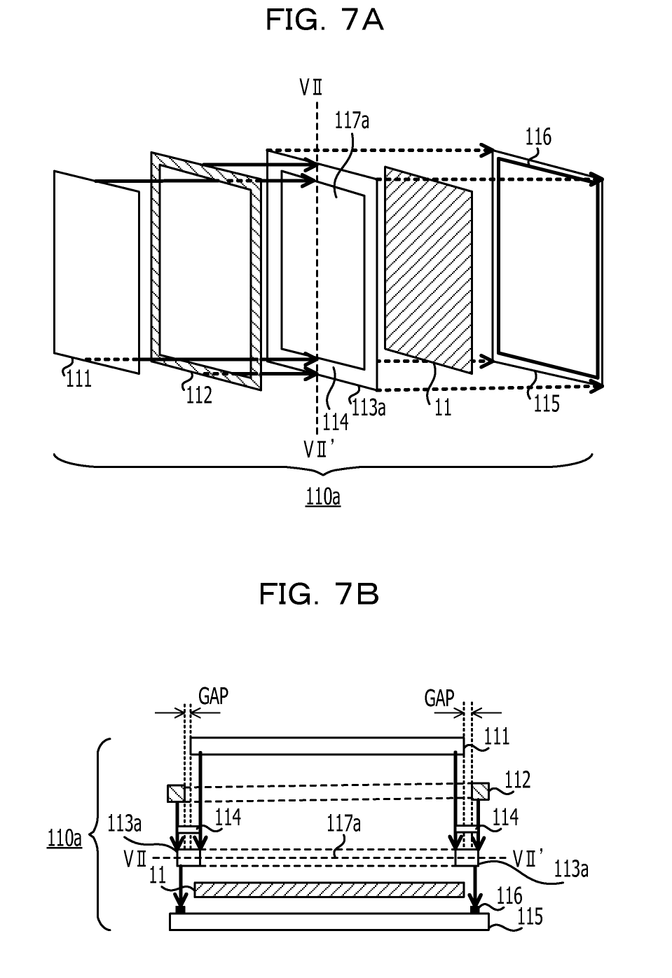

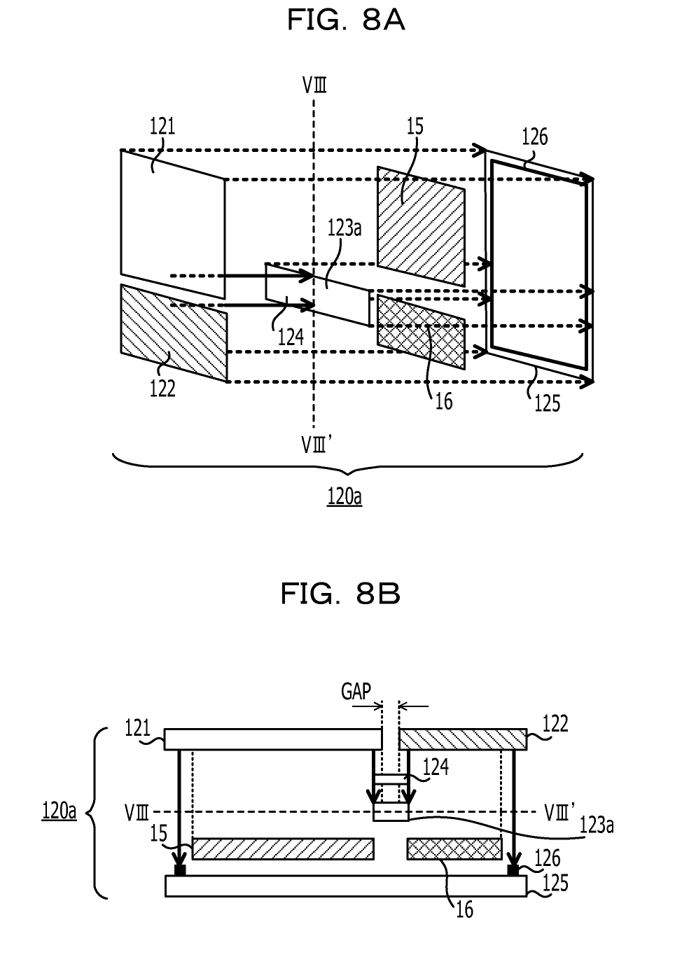

Referring to FIGS. 7A, 7B, 8A and 8B, a mobile phone according to a first modification will be described. The mobile phone according to the first modification is different from the above-described mobile phone 1 in configurations of a front-side part 110a and a rear-side part 120a. Accordingly, to simplify the description, the following description will be given focusing on the front-side part 110a and rear-side part 120a according to the first modification, and the configuration and operation that are the same as those of the mobile phone 1 will be denoted by the same reference numerals, and a detailed description thereof will be omitted. FIG. 7A is an exploded perspective view and FIG. 7B is an exploded cross-sectional view, respectively, illustrating a detailed configuration of the front-side part 110a according to the first modification, in which respective components of the front-side part 110a are illustrated in an exploded manner. FIG. 8A is an exploded perspective view and FIG. 8B is an exploded cross-sectional view, respectively, illustrating a detailed configuration of the rear-side part 120a according to the first modification, in which respective components of the rear-side part 120a are illustrated in an exploded manner.

As illustrated in FIGS. 7A and 7B, similarly to the above-described front-side part 110, the front-side part 110a according to the first modification includes the plastic panel 111, the plastic panel 112, a PET sheet 113a, the main display 11, and the front frame 115. FIG. 7B illustrates a cross-sectional view taken along line VII-VII′ in FIG. 7A.

In the first modification, the shape of the PET sheet 113a is different from that of the above-described PET sheet 113. More specifically, the PET sheet 113a is shaped to cover a gap between the plastic panels 111 and 112. In other words, the PET sheet 113a does not need to cover a portion other than the gap between the plastic panels 111 and 112. Thus, the PET sheet 113a has a frame-like shape with an opening 117a.

Note that, in the first modification, each of the plastic panel 111, the plastic panel 112, and the PET sheet 113a may be attached to the front frame 115 with the double-faced tape 116. That is, in the first modification, the water-tightness of a space defined by the plastic panel 111, the plastic panel 112, the PET sheet 113a, the double-faced tape 116, and the front frame 115 may be ensured. Accordingly, in the first modification, the main display 11 may be disposed in the space defined by the plastic panel 111, the plastic panel 112, the PET sheet 113a, the double-faced tape 116, and the front frame 115.

As illustrated in FIGS. 8A and 8B, similarly to the rear-side part 120, the rear-side part 120a according to the first modification includes the plastic panel 121, the plastic panel 122, a PET sheet 123a, the sub-display 15, the electrostatic sensor 16, and the rear frame 125. FIG. 8B illustrates a cross-sectional view taken along line VIII-VIII′ in FIG. 8A.

In the first modification, the shape of the PET sheet 123a is different from that of the above-described PET sheet 123. More specifically, the PET sheet 123a is shaped so as to cover a gap between the plastic panels 121 and 122. In other words, the PET sheet 123a does not need to cover a portion other than the gap between the plastic panels 121 and 122.

Note that, in the first modification, each of the plastic panel 121, the plastic panel 122, and the PET sheet 123a is attached with the OCA 124, and the PET sheet 123a is attached to the rear frame 125 with the double-faced tape 126. That is, in the first modification, the water-tightness of a space defined by the plastic panel 121, the plastic panel 122, and the PET sheet 123a, the double-faced tape 126, and the rear frame 125 is ensured. Accordingly, in the first modification, the sub-display 15 and the electrostatic sensor 16 are disposed in the space defined by the plastic panel 121, the plastic panel 122, the PET sheet 123a, the double-faced tape 126, and the rear frame 125.

As has been described above, similarly to the mobile phone 1 above, in the first modification too, the gap between the plastic panels 111 and 112 is covered by the PET sheet 113a. Accordingly, the PET sheet 113a prevents water droplets flowing along the gap between the plastic panels 111 and 112 from entering the inside of the front-side part 110a. Thus, the water-tightness of the mobile phone 1 may be ensured. The same technical advantages may also be obtained in the PET sheet 123a of the rear-side part 120a.

The mobile phone according to the first modification may of course appropriately enjoy other technical advantages enjoyed by the mobile phone 1.

### 6. Second Modification

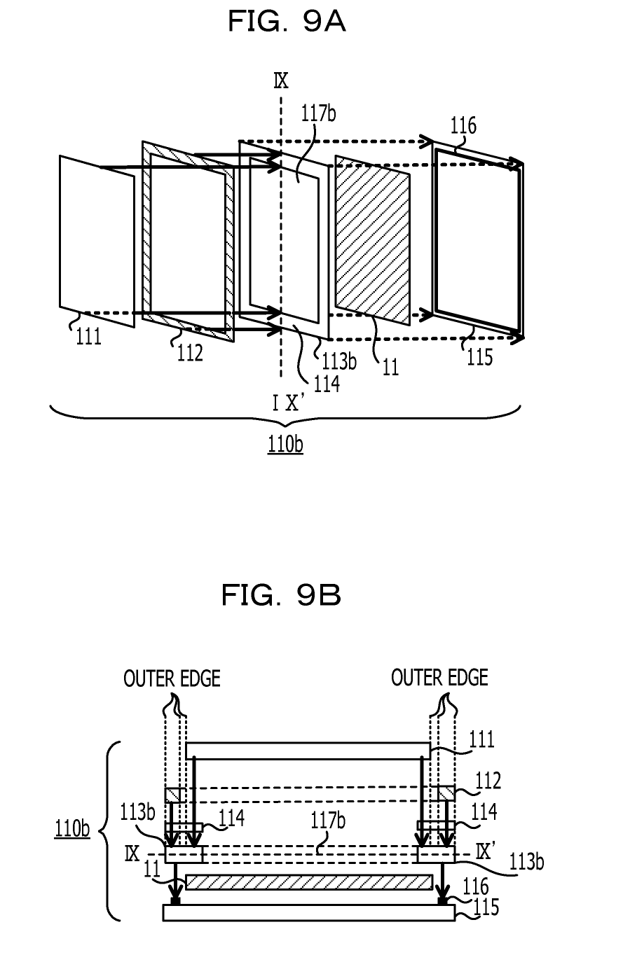

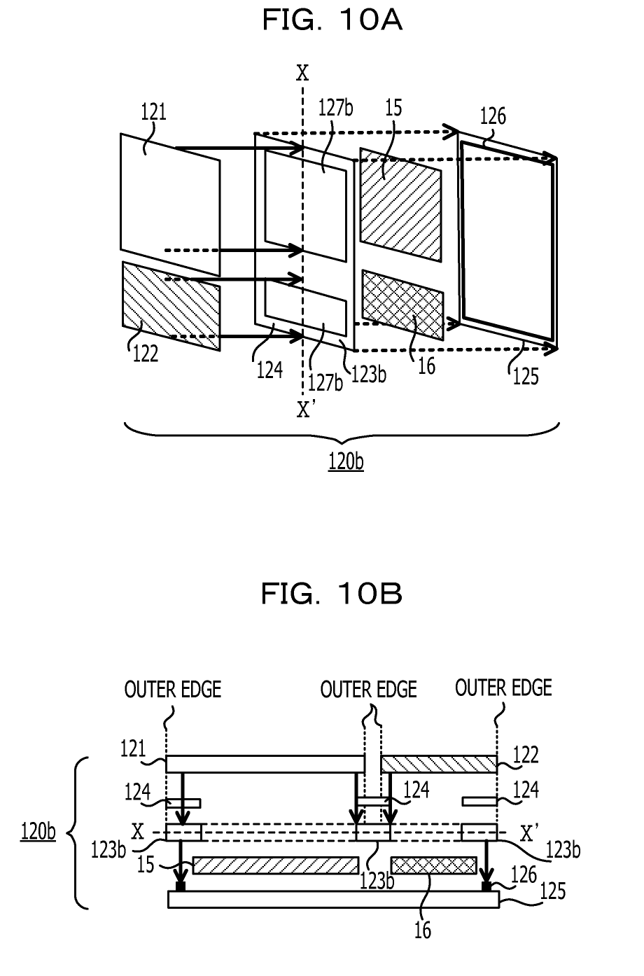

Referring to FIGS. 9A, 9B, 10A and 10B, a mobile phone according to a second modification will be described. The mobile phone according to the second modification is different from the above-described mobile phone 1 in configurations of a front-side part 110b and a rear-side part 120b. Accordingly, to simplify the description, the following description will be given focusing on the front-side part 110b and rear-side part 120b according to the second modification, and the configuration and operation that are the same as those of the mobile phone 1 will be denoted by the same reference numerals, and a detailed description thereof will be omitted. FIG. 9A is an exploded perspective view and FIG. 9B is an exploded cross-sectional view, respectively, illustrating a detailed configuration of the front-side part 110b according to the second modification, in which respective components of the front-side part 110b are illustrated in an exploded manner. FIG. 10A is an exploded perspective view and FIG. 10B is an exploded cross-sectional view, respectively, illustrating a detailed configuration of the rear-side part 120b according to the second modification, in which respective components of the rear-side part 120b are illustrated in an exploded manner.

As illustrated in FIGS. 9A and 9B, similarly to the above-described front-side part 110, the front-side part 110b according to the second modification includes the plastic panel 111, the plastic panel 112, a PET sheet 113b, the main display 11, and the front frame 115. FIG. 9B illustrates a cross-sectional view taken along line IX- IX′ in FIG. 9A.

In the second modification, the shape of the PET sheet 113b is different from those of the above-described PET sheet 113 and PET sheet 113a. More specifically, the PET sheet 113b is shaped to cover a gap between the plastic panels 111 and 112, as well as the outer edges of the plastic panels 111 and 112. In other words, the PET sheet 113b does not need to cover a portion other than the gap between the plastic panels 111 and 112, as well as the outer edges of the plastic panels 111 and 112. Thus, the PET sheet 113b has a frame-like shape with an opening 117b.

As illustrated in FIGS. 10A and 10B, similarly to the rear-side part 120, the rear-side part 120b according to the second modification includes the plastic panel 121, the plastic panel 122, a PET sheet 123b, the sub-display 15, the electrostatic sensor 16, and the rear frame 125. FIG. 10B illustrates a cross-sectional view taken along line X-X′ in FIG. 10A.

In the second modification, the shape of the PET sheet 123b is different from those of the above-described PET sheet 123 and PET sheet 123a. More specifically, the PET sheet 123b is shaped to cover a gap between the plastic panels 121 and 122, as well as the outer edges of the plastic panels 121 and 122. In other words, the PET sheet 123b does not need to cover a portion other than the gap between the plastic panels 121 and 122, and the outer edges of the plastic panels 121 and 122. Thus, the PET sheet 123b has a frame-like shape with openings 127b.

As has been described above, similarly to the mobile phone 1 above, in the second modification too, the gap between the plastic panels 111 and 112 is covered by the PET sheet 113b. Accordingly, the PET sheet 113b prevents water droplets flowing along the gap between the plastic panels 111 and 112 from entering the inside of the front-side part 110b. Thus, the water-tightness of the mobile phone 1 may be ensured. The same technical advantages may also be obtained in the PET sheet 123b of the rear-side part 120b.

The mobile phone according to the second modification may of course appropriately enjoy other technical advantages enjoyed by the mobile phone 1.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that various changes, substitutions, and alterations could be made hereto without departing from the spirit and scope of the invention.

What is claimed is:

1. An electronic device comprising:
a display unit;
a protective member disposed on the display unit to protect the display unit;
a surface member disposed on the same plane as the protective member; and
a waterproof sheet covering at least a gap between the protective member and the surface member, the waterproof sheet is disposed between the display unit and the protective and surface members.

2. The electronic device according to claim 1,
wherein the waterproof sheet is shaped to cover at least outer edges of the protective member and surface member.

3. The electronic device according to claim 1,
wherein the waterproof sheet is shaped to cover the entirety of the protective member and surface member.

4. The electronic device according to claim 1,
wherein the waterproof sheet and the protective member and the surface member are attached to each other with a transparent bonding member.

5. The electronic device according to claim 4,
wherein the bonding member contains an optically clear adhesive (OCA).

6. The electronic device according to claim 1,
wherein at least one of the protective member and the waterproof sheet transmits light.

7. The electronic device according to claim 1,
wherein the waterproof sheet and the protective member are integrally formed, and
wherein the surface member is disposed on the waterproof sheet that is formed integrally with the protective member.

8. The electronic device according to claim 1, further comprising:
a functional portion having a function different from a display function by the display unit at a position where the display unit is not provided, and
wherein the surface member is disposed on the functional portion.

9. The electronic device according to claim 1,
wherein the surface member includes a decorative member for decorating the electronic device.

10. An electronic device comprising:
a protective member disposed on a first portion of the electronic device to protect the first portion;
a surface member disposed on a second portion of the electronic device, which is different from the first portion, to protect the second portion; and
a waterproof sheet covering at least a gap between the protective member and the surface member, the waterproof sheet is disposed between the first and second portions and the protective and surface members.

11. An outer panel attached to an electronic device having a display unit, the outer panel comprising:
a protective member disposed on the display unit to protect the display unit;
a surface member disposed on the same plane as the protective member; and
a waterproof sheet covering at least a gap between the protective member and the surface member, the waterproof sheet is disposed between the display unit and the protective and surface members.
